(19) United States
(12) Patent Application Publication
(10) Pub. No.: US 2025/0153549 A1
(43) Pub. Date: May 15, 2025

(54) VEHICLE SIDE STRUCTURE

(71) Applicant: SUBARU CORPORATION, Tokyo (JP)

(72) Inventors: Chihiro YAMAMOTO, Tokyo (JP); Tomonori AOYAMA, Tokyo (JP)

(73) Assignee: SUBARU CORPORATION, Tokyo (JP)

(21) Appl. No.: 18/930,139

(22) Filed: Oct. 29, 2024

(30) Foreign Application Priority Data
Nov. 10, 2023 (JP) 2023-192538

(51) Int. Cl. B60J 5/04

(52) U.S. Cl. CPC B60J 5/0444; B60J 5/0437

(57) ABSTRACT

A vehicle side structure includes a door, a protruding member, an engagement portion, and a connection member. The door is configured to open and close a side surface opening of a vehicle body of a vehicle. The protruding member is provided on the door and protrudes outward from an outer plate member of the door. The engagement portion is provided in the vehicle body and is engaged with the protruding member is configured to move inward in a vehicle width direction at a time of side collision of the vehicle. The connection member connects the outer plate member of the door with another member and extends in the vehicle width direction. The connection member has a bend starting point portion serving as a starting point of bending of the connection member at the time of side collision of the vehicle.

### CROSS-REFERENCE TO RELATED APPLICATIONS

The present application claims priority from Japanese Patent Application No. 2023-192538 filed on Nov. 10, 2023, the entire contents of which are hereby incorporated by reference.

### BACKGROUND

The disclosure relates to a vehicle side structure including a protruding member provided on a door and an engagement portion provided on a vehicle body and engaged with the protruding member of the door at the time of side collision of the vehicle.

As this type of vehicle side structure, a vehicle side structure including an engagement pin protruding from a rear door and an engagement hole provided in a wheel house peripheral portion of a rear fender and engaged with the engagement pin is known (see, for example, Japanese Unexamined Patent Application Publication (JP-A) No. H6-40259). In JP-A No. H6-40259, when an impact force acts on the rear door from the side of the vehicle body, the engagement hole is restricted so that the rear door does not further move into the vehicle interior by the engagement pin coming into contact with an inner end of the engagement hole.

### SUMMARY

An aspect of the disclosure provides a vehicle side structure. The vehicle side structure includes a door, a protruding member, an engagement portion, and a connection member. The door is configured to open and close a side surface opening of a vehicle body of a vehicle. The protruding member is provided on the door and protrudes outward from an outer plate member of the door. The engagement portion is provided in the vehicle body and is engaged with the protruding member that is configured to move inward in a vehicle width direction at a time of side collision of the vehicle. The connection member connects the outer plate member of the door with another member and extends in the vehicle width direction. The connection member has a bend starting point portion serving as a starting point of bending of the connection member at the time of side collision of the vehicle.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic perspective view of a vehicle illustrating an embodiment of the disclosure;

FIG. 2 is a schematic side explanatory view of a door illustrating an arrangement state of each beam and a bracket;

FIG. 3 is a side explanatory view of a lower beam and the bracket;

FIG. 4 is a partial side sectional view of the door; and

FIG. 5 is a plan view of a bracket.

### DETAILED DESCRIPTION

When a vehicle body is made common between different vehicle types, the position of an engagement portion of the vehicle body is also common between the vehicle types. However, since the shaping of the door is different for each vehicle type, depending on the vehicle type, a layout in which the protruding member provided on the door is relatively separated from the engagement portion may be used. In this case, at the time of side collision of the vehicle, an idle running distance until the protruding member reaches the engagement portion becomes long, and the protruding member and the engagement portion may not be properly engaged.

The disclosure has been made in view of the above circumstances, and it is desirable to provide a vehicle side structure capable of accurately engaging a protruding member of a door and an engagement portion of a vehicle body at the time of side collision even in a layout in which the protruding member of the door and the engagement portion of the vehicle body are relatively separated from each other.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

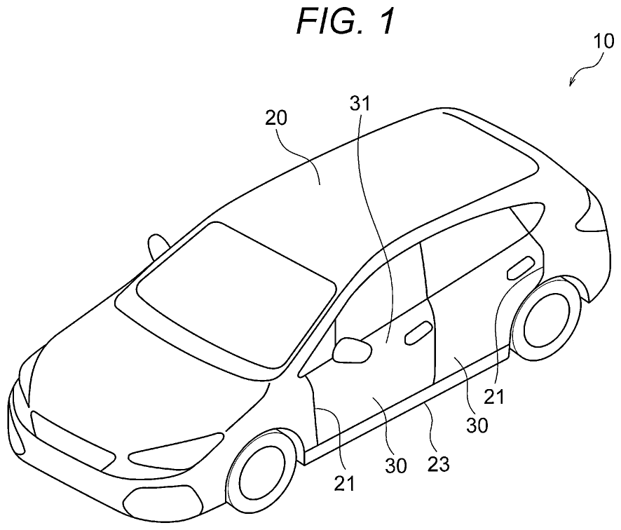

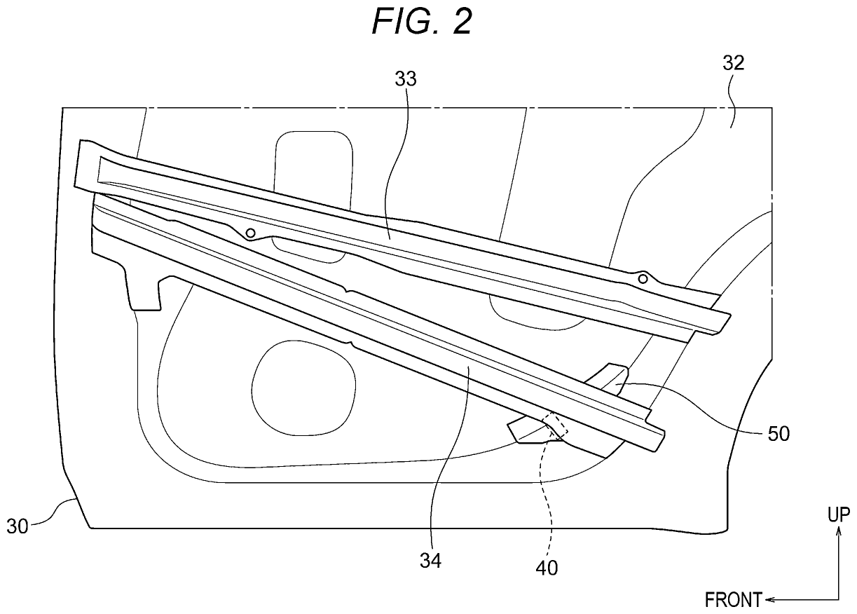

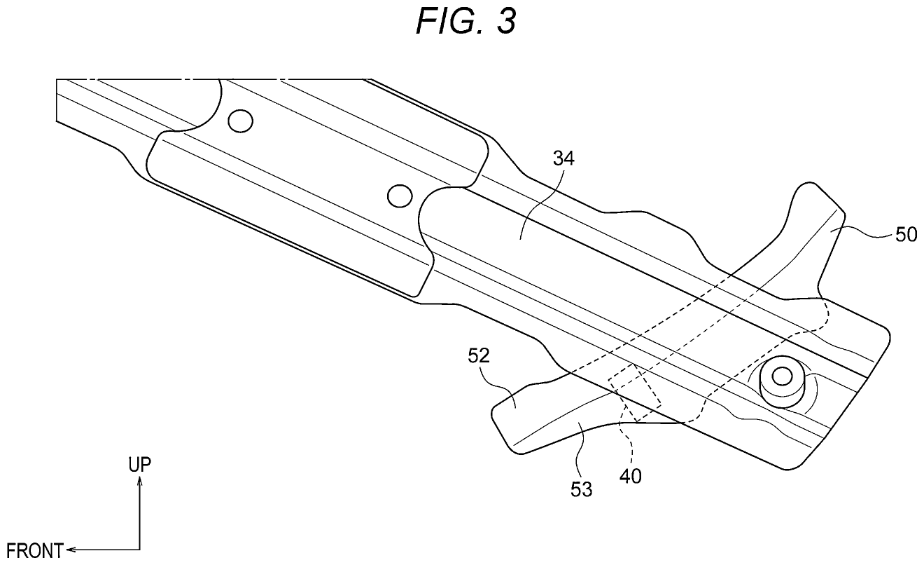

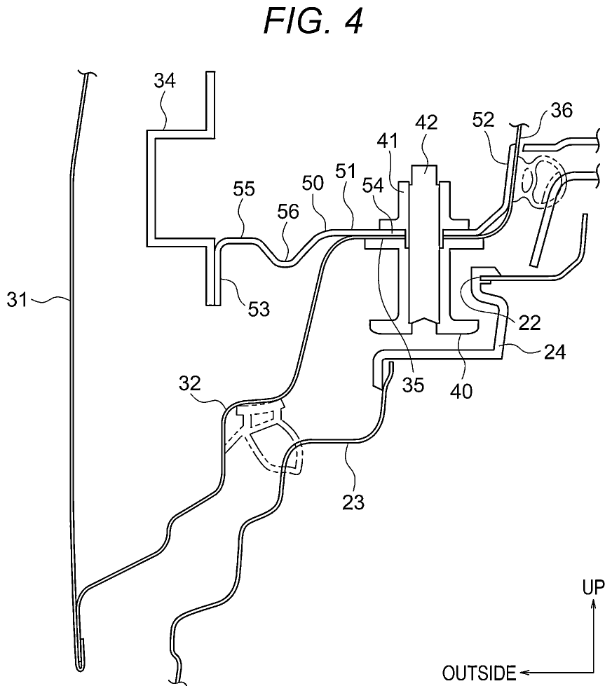

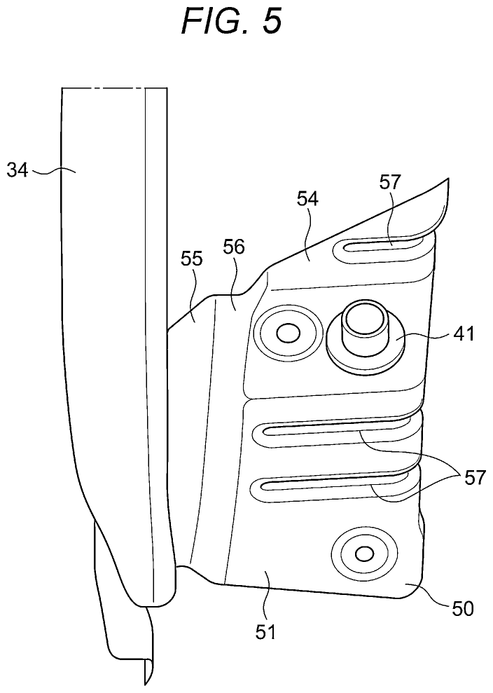

FIGS. 1 to 5 illustrate an embodiment of the disclosure. FIG. 1 is a schematic perspective view of a vehicle. FIG. 2 is a schematic side explanatory view of a door illustrating an arrangement state of each beam and a bracket. FIG. 3 is a side explanatory view of a lower beam and a bracket. FIG. 4 is a partial side sectional view of the door. FIG. 5 is a plan view of the bracket.

As illustrated in FIG. 1, an automobile vehicle 10 includes doors 30 for opening and closing a side surface opening 21 of a vehicle body 20. The vehicle side structure of the present embodiment is applied to a front door of the vehicle 10. In addition to an outer panel 31 as an outer panel forming the design surface of the vehicle 10, a door 30 includes an inner panel 32 as an outer plate member, and an upper beam 33 and a lower beam 34 extending in a front-rear direction as illustrated in FIG. 2. The upper beam 33 and the lower beam 34 are formed in a hat-shaped cross section, and are bent in an intended deformation mode at the time of side collision of the vehicle. The door 30 has a catcher pin 40 protruding outward from the inner panel 32, and the vehicle body 20 is provided with an engagement portion 22 (see FIG. 4) that engages with the catcher pin 40 at the time of side collision of the vehicle 10. In the present embodiment, the engagement portion 22 is disposed on a side sill 23 forming a lower side of the side surface opening 21 of the vehicle body 20. As illustrated in FIG. 3, the door 30 includes a bracket 50 to which the catcher pin 40 is attached. The bracket 50 as a connection member connects the inner panel 32 with the lower beam 34.

As illustrated in FIG. 4, the inner panel 32 has a vehicle width extending portion 35 extending in a vehicle width direction, and the catcher pin 40 protrudes downward from the vehicle width extending portion 35. The catcher pin 40 as a protruding member is attached to the door 30 side by a nut 41 provided on an upper surface of the bracket 50 and a bolt 42 inserted through the inner panel 32 and the bracket 50 and screwed with the nut 41. In the present embodiment, the engagement portion 22 is formed by cutting out the side sill 23, and the catcher pin 40 is positioned at a portion where the side sill 23 is cut out in a state where the door 30 is closed. The engagement portion 22 is covered with a covering member 24.

As illustrated in FIG. 4, the bracket 50 includes a vehicle width extending portion 51 on which the nut 41 is provided and extending in the vehicle width direction, an inner flange 52 extending upward from an inner end in the vehicle width direction of the vehicle width extending portion 51, and an outer flange 53 extending downward from an outer end in the vehicle width direction of the vehicle width extending portion 51. In the bracket 50, the inner flange 52 is joined to a vertically extending portion 36 of the inner panel 32, and the outer flange 53 is joined to the lower beam 34. An inside in the vehicle width direction of the vehicle width extending portion 51 is disposed to overlap the vehicle width extending portion 35 of the inner panel 32, and forms an attachment portion 54 to which the catcher pin 40 is attached. An outside in the vehicle width direction of the vehicle width extending portion 51 forms an extending portion 55 extending in the vehicle width direction in a space between the inner panel 32 and the lower beam 34 inside the door 30.

As illustrated in FIG. 5, a recess 56 as a bend starting point portion is formed in the extending portion 55. In the present embodiment, the recess 56 of the bracket 50 extends in the front-rear direction, and when a load to compress in the vehicle width direction acts on the vehicle width extending portion 51 of the bracket 50, the bracket 50 is bent so as to be folded in the vehicle width direction with the recess 56 as a starting point. In the present embodiment, the recess 56 is formed so as to protrude downward.

Beads 57 extending in the vehicle width direction are formed on the attachment portion 54. The beads 57 constitutes a shape maintaining portion for maintaining the shape of the attachment portion 54 at the time of side collision of the vehicle. In the present embodiment, the beads 57 are formed on a front side and a rear side of the nut 41. One bead is arranged on the front side of the nut 41, and two beads are arranged side by side in the front-rear direction on the rear side of the nut 41.

With the vehicle side structure configured as described above, when the door 30 is crushed from the outside toward the inside in the vehicle width direction at the time of side collision of the vehicle 10, the bracket 50 inside the door 30 bends with the recess 56 as a starting point. In the present embodiment, since the recess 56 is formed in the front-rear direction, the bracket 50 is reliably bent at the position of the recess 56. As described above, by positively bending the bracket 50 in the intended deformation mode, the inner panel 32 and the catcher pin 40 can be moved toward the inside in the vehicle width direction as intended. While the bracket 50 is bent at the recess 56, the posture of the attachment portion 54 of the bracket 50 does not change significantly, and the catcher pin 40 is not in a tumbling mode in which the axial direction changes significantly. In this manner, the catcher pin 40 is prevented from being in a tumbling mode, and the catcher pin 40 can be engaged with the engagement portion 22 in an intended posture. Thus, even in a layout in which the catcher pin 40 of the door 30 and the engagement portion 22 of the vehicle body 20 are relatively separated from each other, they can be accurately engaged at the time of side collision. Therefore, the input from the door 30 side can be accurately transmitted to the vehicle body 20 side, and the vehicle 10 can reliably exhibit the intended collision performance at the time of side collision.

That is, even in a case where the position of the catcher pin 40 is relatively separated from the engagement portion 22 due to different shaping of the door 30 in different vehicle types, the catcher pin 40 and the engagement portion 22 can be accurately meshed. Thus, the platform of the vehicle body 20 can be shared by different vehicle types, and the manufacturing cost of the vehicle 10 can be greatly reduced.

With the vehicle side structure of the present embodiment, the bracket 50 is bent with the recess 56 as a starting point at the time of side collision of the vehicle 10, and deformation of the attachment portion 54 is suppressed by each bead 57. Thus, the posture of the catcher pin 40 can be stabilized at the time of side collision of the vehicle 10, and the catcher pin 40 and the engagement portion 22 can be more accurately engaged.

At the time of side collision of the vehicle 10, an input corresponding to deformation of the lower beam 34 acts on the bracket 50 from the lower beam 34. In the present embodiment, since the lower beam 34 has a hat-shaped cross section and is actively bent at the time of side collision, a large tensile force acts on the bracket 50 as compared with a pipe-shaped beam member. At this time, since the bracket 50 is bent with the recess 56 as a starting point, the catcher pin 40 can be moved inward in the vehicle width direction without being affected by the input from the lower beam 34. Therefore, specifications of the lower beam 34 can be determined without considering the behavior of the catcher pin 40 at the time of side collision of the vehicle 10, and the degree of freedom in designing the door 30 is dramatically improved. Here, if the recess 56 is not formed in the bracket 50, the catcher pin 40 turns into a tumbling mode by the input from the lower beam 34 to the bracket 50 at the time of side collision, and a lower end side thereof is tilted outward in the vehicle width direction and is disengaged from the engagement portion 22 of the vehicle body 20. That is, the recess 56 of the bracket 50 can be said to be a structure that solves the problem that the catcher pin is detached from the vehicle body side when the beam member that is actively bent at the time of side collision is used.

In the above embodiment, the recess 56 as the bend starting point portion is formed in the bracket 50 over the front-rear direction, but the recess may be partially formed in the front-rear direction. Further, for example, the bend starting point portion can be a hole or the like instead of the recess, and the configuration of the bend starting point portion can be changed in any manner.

In the above embodiment, the bracket 50 of the catcher pin 40 is illustrated as the connection member in which the bend starting point portion is formed, but for example, the connection member may be a reinforcement that connects the inner panel 32 with the lower beam 34 regardless of the catcher pin 40. In the embodiment described above, the bracket 50 has the three beads 57 for maintaining the shape of the attachment portion 54 at the time of side collision of the vehicle 10. However, the shape and number of beads can be changed in any manner. For example, the shape maintaining portion can be formed by partially changing the plate thickness, the material, and the like, and further, in a case where the shape of the attachment portion can be sufficiently maintained by the bending action of the connection member, the shape maintaining portion can be omitted. In the above embodiment, the bracket 50 is connected with the lower beam 34, but may be connected with a member other than the beam member.

Although the embodiments of the disclosure have been described above, the embodiments described above do not limit the disclosure according to the claims. It should be noted that not all combinations of features described in the embodiments are related to the means for solving the problems of the disclosure.

According to the disclosure, even in a layout in which a protruding member of a door and an engagement portion of the vehicle body are relatively separated from each other, they can be accurately engaged at the time of side collision.

1. A vehicle side structure comprising:
a door configured to open and close a side surface opening of a vehicle body of a vehicle;
a protruding member provided on the door and protruding outward from an outer plate member of the door;
an engagement portion provided in the vehicle body and engaged with the protruding member that is configured to move inward in a vehicle width direction at a time of side collision of the vehicle; and
a connection member that connects the outer plate member of the door with another member and extends in the vehicle width direction, wherein
the connection member has a bend starting point portion serving as a starting point of bending of the connection member at the time of the side collision of the vehicle.

2. The vehicle side structure according to claim 1, wherein the connection member is a bracket to which the protruding member is attached.

3. The vehicle side structure according to claim 2, wherein the bracket includes a shape maintaining portion for maintaining a shape of an attachment portion of the protruding member at the time of the side collision of the vehicle.

4. The vehicle side structure according to claim 3, wherein
the door includes a beam member extending in a front-rear direction, and
the bracket connects the outer plate member with the beam member.

5. The vehicle side structure according to claim 1, wherein the bend starting point portion has a recess formed in the connection member in the front-rear direction.

6. The vehicle side structure according to claim 2, wherein the bend starting point portion has a recess formed in the connection member in the front-rear direction.

7. The vehicle side structure according to claim 3, wherein the bend starting point portion has a recess formed in the connection member in the front-rear direction.

8. The vehicle side structure according to claim 4, wherein the bend starting point portion has a recess formed in the connection member in the front-rear direction.
